(19) United States
(12) Patent Application Publication
(10) Pub. No.: US 2026/0251598 A1
(43) Pub. Date: Aug. 27, 2026

(54) DEFECT INSPECTION APPARATUS USING SPOT BEAMS FORMED OVER TIME AND METHOD OF INSPECTING DEFECT

(71) Applicant: SAMSUNG ELECTRONICS CO., LTD., Suwon-si (KR)

(72) Inventors: Sangsu Hong, Suwon-si (KR); Jehyun Ha, Suwon-si (KR); Joongbae Kim, Cheonan-si (KR); Jinsung Rho, Seoul (KR); Daehee Kim, Cheonan-si (KR); Doyoon Kim, Daejeon (KR); Geuntak Yuk, Daejeon (KR); Jaehyun Lim, Cheonan-si (KR); Haegu Lee, Suwon-si (KR); Jaemin Jeon, Suwon-si (KR)

(73) Assignees: SAMSUNG ELECTRONICS CO., LTD., Suwon-si (KR); HANBAT NATIONAL UNIVERSITY, Daejeon (KR); KONGJU NATIONAL UNIVERSITY INDUSTRY-UNIVERSITY COOPERATION FOUNDATION, Gongju-si (KR)

(21) Appl. No.: 19/547,187

(22) Filed: Feb. 23, 2026

(30) Foreign Application Priority Data
Feb. 27, 2025 (KR) 10-2025-0025639

(51) Int. Cl. G01N 25/72

(52) U.S. Cl. CPC G01N 25/72

(57) ABSTRACT

A defect inspection apparatus includes a laser generator configured to generate a pulse laser having a constant period based on a pulse signal, a laser controller configured to form a plurality of spot beams by dividing the pulse laser over time such that the pulse laser proceeds in different directions in each constant period based on a control signal matched with the pulse signal and heat a surface of a target structure by sequentially emitting the plurality of spot beams to the target structure, an image detector configured to generate at least one thermal image by detecting thermal radiation emitted from the target structure irradiated by the plurality of spot beams, and a controller configured to detect a surface defect of the target structure by processing the at least one thermal image.

### CROSS-REFERENCE TO RELATED APPLICATION

This application is based on and claims priority to Korean Patent Application No. 10-2025-0025639, filed on Feb. 27, 2025, in the Korean Intellectual Property Office, the disclosure of which is incorporated by reference herein in its entirety.

### BACKGROUND

The present disclosure relates to a defect inspection apparatus and a method of inspecting defects. More particularly, example embodiments relate to a defect inspection apparatus and a method of inspecting defects using a non-destructive surface inspection method.

In order to inspect surface defects of a semiconductor device, it is common to employ a non-destructive inspection method. For example, a continuous wave laser may be emitted onto the semiconductor device and thermal radiation emitted from the semiconductor device may be detected with an infrared camera, to detect surface defects of the semiconductor device. In this case, the infrared camera may detect the thermal radiation using a transient thermal measurement method that measures temperature variations over time. However, since the continuous wave laser must be continuously emitted to detect the thermal radiation using a transient thermal measurement method, there is a problem in that the analysis time becomes prolonged.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a defect inspection apparatus that may have high process speed.

One or more example embodiments provide a method of inspecting defect in a semiconductor device that may have high process speed.

According to an aspect of an example embodiment, a defect inspection apparatus may include a laser generator configured to generate a pulse laser having a constant period based on a pulse signal, a laser controller configured to form a plurality of spot beams by dividing the pulse laser over time such that the pulse laser proceeds in different directions in each constant period based on a control signal matched with the pulse signal and heat a surface of a target structure by sequentially emitting the plurality of spot beams to the target structure, an image detector configured to generate at least one thermal image by detecting thermal radiation emitted from the target structure irradiated by the plurality of spot beams, and a controller configured to detect a surface defect of the target structure by processing the at least one thermal image.

According to an aspect of an example embodiment, a defect inspection apparatus may include a laser generator configured to generate a pulse laser having a constant period based on a pulse signal, a laser controller configured to form a plurality of spot beams by dividing the pulse laser over time such that the pulse laser proceeds in different directions in each constant period based on a control signal matched with the pulse signal and heat a surface of a target structure by sequentially emitting the plurality of spot beams to the target structure, an image detector configured to generate a plurality of thermal images by detecting thermal radiation emitted from the target structure over time after the plurality of spot beams are entirely emitted to the target structure and a controller configured to detect a surface defect of the target structure by selecting and processing a target thermal image among the plurality of thermal images.

According to an aspect of an example embodiment, a defect inspection apparatus may include a laser generator configured to generate a pulse laser having a constant period based on a pulse signal, a laser controller including a galvanometer scanner including a plurality of mirrors configured to reflect the pulse laser, the laser controller configured to divide the pulse laser over time and form a plurality of spot beams by changing angles of the plurality of mirrors for each constant period of the pulse laser based on a control signal and heat a surface of a target structure in a raster scan manner by sequentially emitting the plurality of spot beams onto the target structure, an image detector configured to generate at least one thermal image by detecting thermal radiation emitted from the target structure over time after the plurality of spot beams are entirely emitted to the target structure, and a controller configured to generate an inspection image illustrating an outline of a surface defect by applying a Sobel filter to the at least one thermal image, and detect the surface defect based on the inspection image.

### BRIEF DESCRIPTION OF DRAWINGS

The above and other aspects, features, and advantages of certain example embodiments of the present disclosure will be more apparent from the following description taken in conjunction with the accompanying drawings, in which.

FIG. 1 is a block diagram illustrating a defect inspection apparatus in accordance with example embodiments.

FIG. 2 is a graph illustrating an output over time of a pulse laser generated by a laser generator of FIG. 1.

FIG. 3 is a block diagram illustrating a laser controller of FIG. 1.

FIG. 4 shows graphs illustrating control signals for a first mirror and a second mirror that are output to the laser controller of FIG. 3.

FIG. 5 is a plan view illustrating a target structure supported on a stage of FIG. 1.

FIG. 6 is a block diagram illustrating an image detector of FIG. 1.

FIG. 7 is a diagram illustrating a thermal image acquired by the image detector of FIG. 6.

FIG. 8 is an enlarged diagram illustrating portion ‘A’ in FIG. 7.

FIG. 9 is a diagram illustrating an inspection image generated from the thermal image of FIG. 7.

FIG. 10 is a diagram illustrating thermal images in accordance with example embodiments.

FIG. 11A is an enlarged view of a portion ‘B’ of FIG. 10.

FIG. 11B is an enlarged view of a portion ‘C’ of FIG. 10.

FIG. 12 is a diagram illustrating thermal images according to example embodiments.

FIG. 13 is a diagram illustrating inspection images according to example embodiments.

FIG. 14 is a flowchart illustrating a method of inspecting a surface defect of a semiconductor device according to example embodiments.

FIG. 15 is a block diagram of a system according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, "at least one of a, b, and c," should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

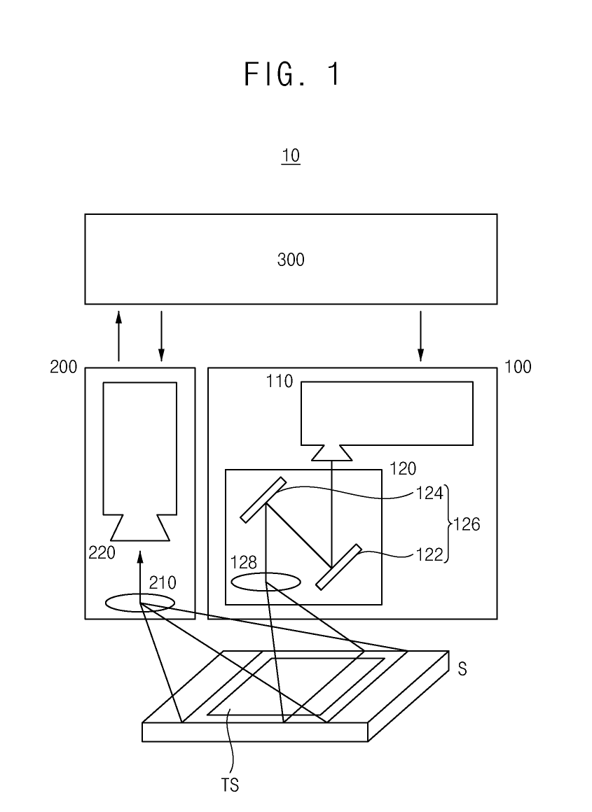

FIG. 1 is a block diagram illustrating a defect inspection apparatus in accordance with example embodiments. Referring to FIG. 1, a defect inspection apparatus 10 may include a stage S configured to support a target structure TS, a laser emitting assembly 100 configured to emit a plurality of spot beams SB onto the target structure TS, an image detector 200 configured to detect thermal radiation emitted from the target structure TS to obtain a thermal image TI, and a controller 300 configured to detect a surface defect of the target structure TS based on the thermal image TI.

In example embodiments, the defect inspection apparatus 10 may include an inspection apparatus that heats a surface of the semiconductor device, such as a semiconductor chip or semiconductor package, with a laser to acquire a thermal image, and inspects the surface defect by recognizing a portion where an abnormal heat flow occurs in the thermal image as a defect.

In example embodiments, the laser emitting assembly 100 may include a laser generator 110 configured to generate a pulse laser P having periodicity and a laser controller 120 configured to divide the pulse laser P into a plurality of spot beams SB, and sequentially emit the plurality of spot beams SB locally onto the target structure TS to heat the surface of the target structure TS.

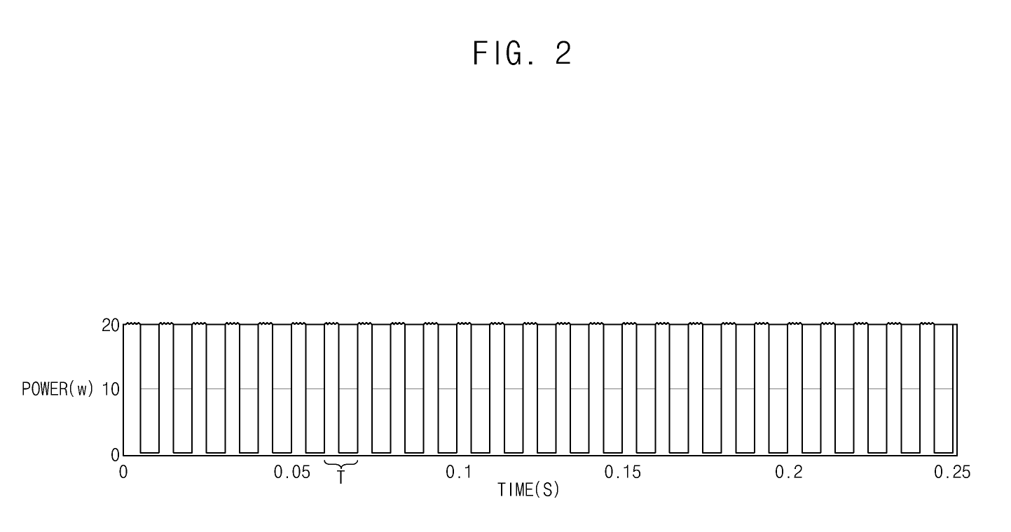

FIG. 2 is a graph illustrating an output over time of a pulse laser generated by a laser generator of FIG. 1. As illustrated in FIG. 2, the laser generator 110 may generate the pulse laser P in response to a trigger signal, which is an inspection start signal applied from the controller 300. The controller 300 may generate a pulse signal having a square waveform with a constant period T. By applying the pulse signal to the laser generator 110, the laser generator 110 may generate the pulse laser P that is repeatedly emitted with an active mode and an inactive mode within the constant period T according to the square waveform.

The laser generator 110 may generate a laser having characteristics suitable for inspecting the surface of the target structure TS according to the pulse signal. For example, the pulse laser P may have an average output within a range of 100 W or less. The pulse energy of the pulse laser P may be within a range of 10 mJ or less. The pulse duration of the pulse laser P may be within a range of 10 ms or less. The pulse laser P may have a circular or elliptical shape. The pulse signal may be a signal for generating the pulse laser P having an intensity sufficient to cause a temperature change on the surface of the target structure TS.

In example embodiments, the laser controller 120 may include a plurality of mirrors 126 and a lens portion 128. The laser controller 120 may be a galvanometer scanner including a pair of galvanometer mirrors to continuously emit the pulse laser P from one position to a predetermined position of the target structure TS along a predetermined scanning direction. The laser controller 120 may control the plurality of mirrors 126 and the lens portion 128 according to control signals applied from the controller 300.

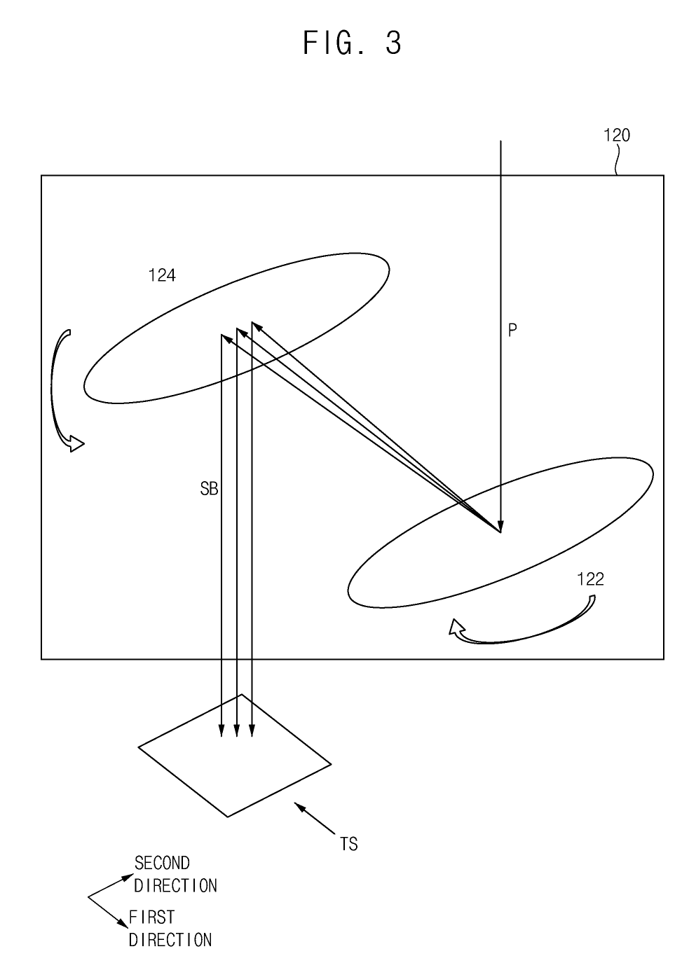

FIG. 3 is a block diagram illustrating a laser controller of FIG. 1. As illustrated in FIG. 3, the laser controller 120 may divide the pulse laser P into the plurality of spot beams SB by controlling the plurality of mirrors 126 in response to the control signals input from the controller 300.

The plurality of mirrors 126 may reflect the pulse laser P in different directions to change a path of the pulse laser P. For example, the plurality of mirrors 126 may include a first mirror 122 and a second mirror 124. The first mirror 122 and the second mirror 124 may be provided to rotate about their own central axes in predetermined directions. Accordingly, as the first mirror 122 and the second mirror 124 are rotated over time, the pulse laser P may be divided into different paths over time thereby forming the plurality of spot beams SB. For example, in each period T of the pulse laser P, the rotational angles of the plurality of mirrors 126 may be changed to divide the pulse laser P into the plurality of spot beams SB.

The lens portion 128 may adjust sizes and foci of the plurality of spot beams SB before the plurality of spot beams SB are emitted onto the target structure TS. The plurality of spot beams SB formed by the plurality of mirrors 126 may be incident on the lens portion 128. The lens portion 128 may adjust the plurality of spot beams SB to be focused on the target structure TS. The lens portion 128 may include a condenser lens that collects light or a diffusion lens that diffuses light. The lens portion 128 may adjust the size and energy of the plurality of spot beams SB. For example, the lens portion 128 may adjust the size such that each diameter of the plurality of spot beams SB is within a range of 1.5 mm or less.

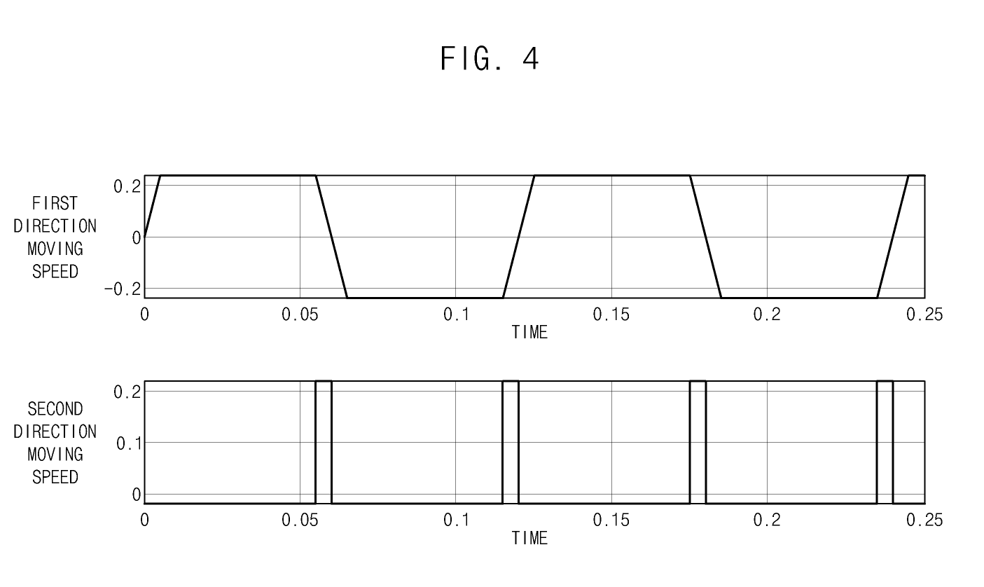

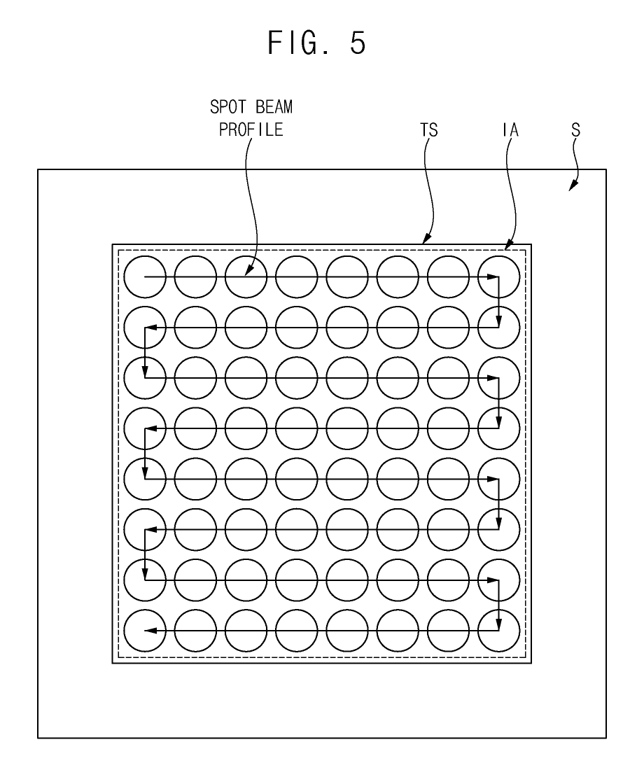

FIG. 4 shows graphs illustrating control signals for a first mirror and a second mirror that are output to the laser controller of FIG. 3. FIG. 5 is a plan view illustrating a target structure supported on a stage of FIG. 1. As illustrated in FIGS. 4 and 5, the laser controller 120 may emit the plurality of spot beams SB onto the target structure TS. For example, the laser controller 120 may emit the plurality of spot beams SB onto the target structure TS to have a raster scan profile.

The target structure TS may be placed on the stage S. The target structure TS may be a semiconductor device including a semiconductor chip. The target structure TS may have an irradiation area IA corresponding to a region on which the plurality of spot beams SB are emitted on one surface. The irradiation area IA may have a rectangular shape extending in a first direction X and a second direction Y perpendicular to the first direction X. For example, a width of the irradiation area IA may be within a range of 9.5 mm or less, and a height of the irradiation area IA may be within a range of 13.3 mm or less.

The laser controller 120 may be driven to control a position at which the plurality of spot beams SB are emitted according to the control signal. For example, the first mirror 122 may be controlled to reflect the incident pulse laser P at a predetermined angle to control movements of the plurality of spot beams SB in the first direction X on the target structure TS. The second mirror 124 may be controlled to reflect the pulse laser P reflected from the first mirror 122 at a predetermined angle to control movements of the plurality of spot beams SB in the second direction Y on the target structure TS.

The control signal may match the pulse signal. The control signal may control the laser controller 120 so that the plurality of spot beams SB move and are emitted in the first direction X on the target structure TS, and after a predetermined number of periods of the pulse signal, move in the opposite direction of the first direction X, and repeat the irradiation of the target structure TS. Likewise, the control signal may control the plurality of spot beams SB to move and emit in the second direction Y on the target structure TS after the predetermined number of periods of the pulse signal. The period of the control signal may be variably determined according to the pulse signal.

The laser controller 120 may control the plurality of mirrors 126 based on the control signal to sequentially emit the plurality of spot beams SB on the plurality of points on the irradiation area IA along the raster scan profile. For example, the laser controller 120 may control the plurality of spot beams SB to be emitted on the irradiation area IA to be spaced apart along the first direction X, and when reaching one side or the opposite side of the irradiation area IA, emitted again along the first direction X at a position spaced apart in the second direction Y, thereby repeatedly irradiating a plurality of points arranged at predetermined intervals in the first direction X and the second direction Y within the irradiation area IA along the raster scan profile. The laser controller 120 may control a moving speed of the pulse laser P on the irradiation area IA to be within a range of 10 m/s or less.

In example embodiments, the laser generator 110 may divide a single pulse laser P over time to form the plurality of spot beams SB. Accordingly, compared with a related art system in which spot beams are formed through a beam splitter having holes of a predetermined size, there may be an advantage in that the shape and size of the spot beam can be freely adjusted. In addition, since energy loss of the beam caused by the beam splitter can be prevented, and since it is unnecessary to periodically replace the beam splitter as in the related art, the defect inspection apparatus according to example embodiments may have advantages of high process promptness and efficiency.

In this embodiment, it has been described that the laser controller 120 controls the pulse laser P along a raster scan profile to form the plurality of spot beams SB, but the profile of the plurality of spot beams SB is not limited thereto, and the plurality of spot beams SB may be emitted onto the target structure TS using other profiles.

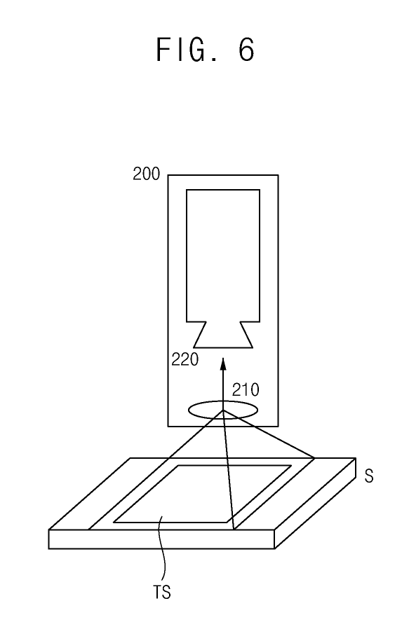

FIG. 6 is a block diagram illustrating an image detector of FIG. 1. As illustrated in FIG. 6, the image detector 200 may include a focusing lens 210 and a thermal imaging camera 220. The image detector 200 may detect thermal radiation emitted from the heated target structure TS irradiated with the plurality of spot beams SB, to generate at least one thermal image TI.

The focusing lens 210 may concentrate the thermal radiation emitted from the target structure TS onto the thermal imaging camera 220. As the plurality of spot beams SB are emitted onto the target structure TS, a plurality of points on the target structure TS irradiated with the plurality of spot beams SB may be heated to form a plurality of thermal points TP that emit thermal radiation. The plurality of thermal points TP may be arranged in a shape corresponding to a profile of the plurality of spot beams SB. For example, the plurality of thermal points TP may be arranged in an array form in which they are spaced apart from each other at predetermined intervals in the first direction X and the second direction Y. The thermal radiation generated from each of the plurality of thermal points TP may be incident on the focusing lens 210.

The focusing lens 210 may be configured to adjust magnification so that the thermal radiation are concentrated onto the thermal imaging camera 220 to allow the thermal imaging camera 220 to generate an image having an optimal resolution according to a size of the irradiation area IA and a distance to the irradiation area IA of the target structure TS.

The thermal imaging camera 220 may include an infrared measurement camera. The thermal imaging camera 220 may generate the shape of the thermal radiation of the target structure TS received through the focusing lens 210 as a thermal image TI. The thermal imaging camera 220 may include a pulse-type thermal imaging camera that detects thermal radiation emitted from the inspection object instantaneously heated.

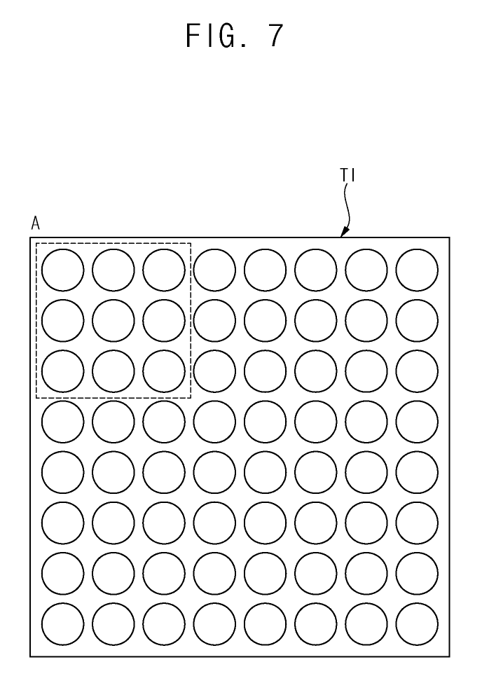

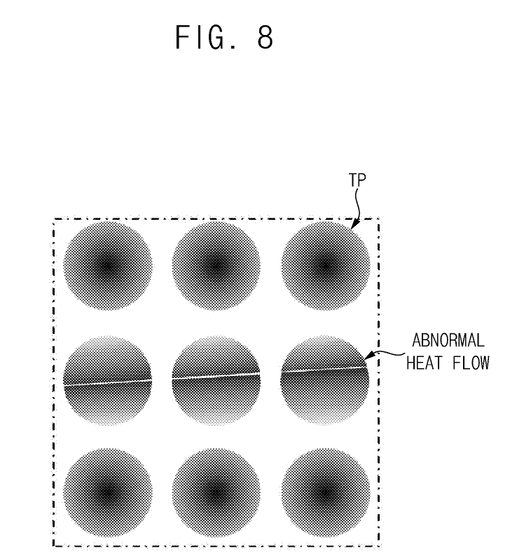

FIG. 7 is a view illustrating a thermal image acquired by the image detector of FIG. 6. FIG. 8 is an enlarged view illustrating portion ‘A’ in FIG. 7. As illustrated in FIGS. 7 and 8, the thermal image TI may represent a temperature distribution on the irradiation area IA by detecting thermal radiation emitted from the target structure TS. For example, a portion having a higher temperature may be expressed in a darker color and a portion having a lower temperature may be expressed in a lighter color.

The thermal imaging camera 220 may generate at least one thermal image TI. The thermal imaging camera 220 may detect thermal radiation generated from the target structure TS, after the plurality of spot beams SB are entirely emitted onto the target structure TS (i.e., after the plurality of spot beams SB have completed being emitted along the predetermined path and have irradiated all desired points on the target structure TS). Since the surface of the target structure TS may be instantaneously heated by the plurality of spot beams SB, the thermal image TI may have a temperature distribution in which the center of each of the plurality of thermal points TP appears darker. In this case, when a surface defect exists on the surface of the target structure TS, heat transfer is not smoothly performed on the surface defect, and thus an abnormal heat flow, such as a discontinuity of the heat distribution, may occur in the thermal image TI as shown in FIG. 8. Subsequently, the thermal imaging camera 220 may transfer at least one generated thermal image TI to the controller 300.

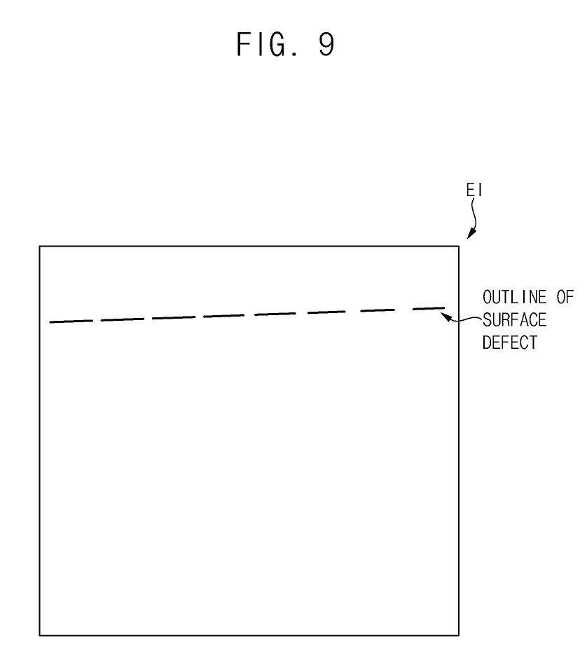

FIG. 9 is a view illustrating an inspection image generated from the thermal image of FIG. 7. As illustrated in FIG. 9, the controller 300 may post-process the thermal image TI to generate an inspection image EI for visual confirmation of the surface defect. The controller 300 may detect the surface defect by using a method of recognizing, as a defect, a case in which abnormal heat transfer distribution occurs, such as a blocked or overheated portion, when the surface defect exists on the target structure TS.

Specifically, the controller 300 may perform post-processing on the thermal image TI. The controller 300 may apply a Sobel filter to the thermal image TI. The Sobel filter may correspond to a filter that extracts an edge by determining a gradient of pixel values in the image. The controller 300 may generate the inspection image EI by marking an area in which the temperature distribution rapidly changes on the thermal image TI using the Sobel filter, thereby representing an outline of the surface defect. Since the inspection image EI is an image including an outline of a portion in which a surface defect occurs, the controller 300 may detect the surface defect of the target structure TS by identifying a target as having a defect when an outline appears on the inspection image EI, and identifying the target as being defect-free when no outline appears on the inspection image EI.

As described above, the defect inspection apparatus 10 may include the laser emitting assembly 100 configured to emit the plurality of spot beams SB onto the target structure TS, the image detector 200 configured to detect thermal radiation emitted from the target structure TS to generate the thermal image TI, and the controller 300 configured to generate the inspection image EI for visual confirmation of surface defects on the target structure TS based on the thermal image TI.

The laser controller 120 of the laser emitting assembly 100 may divide the pulse laser P formed in the laser generator 110 over time to form the plurality of spot beams SB, and may sequentially emit the plurality of spot beams SB onto the target structure TS.

Accordingly, the defect inspection apparatus 10 according to example embodiments may instantaneously heat the target structure TS using the pulse laser P (e.g., using the spot beams SB) and detect the surface defect through the pulse-type thermal imaging camera 220. Accordingly, compared with a related art system using a transient-type infrared camera, the surface defect can be detected at a higher speed. In addition, since a separate beam mask is not used, energy loss is reduced, and the shape and size of the irradiated beam can be freely adjusted.

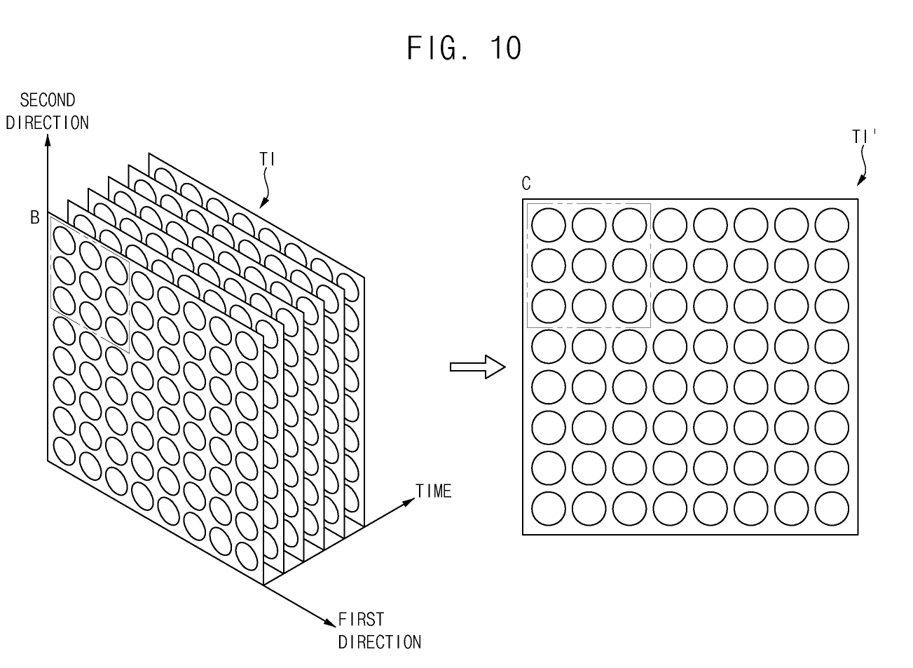

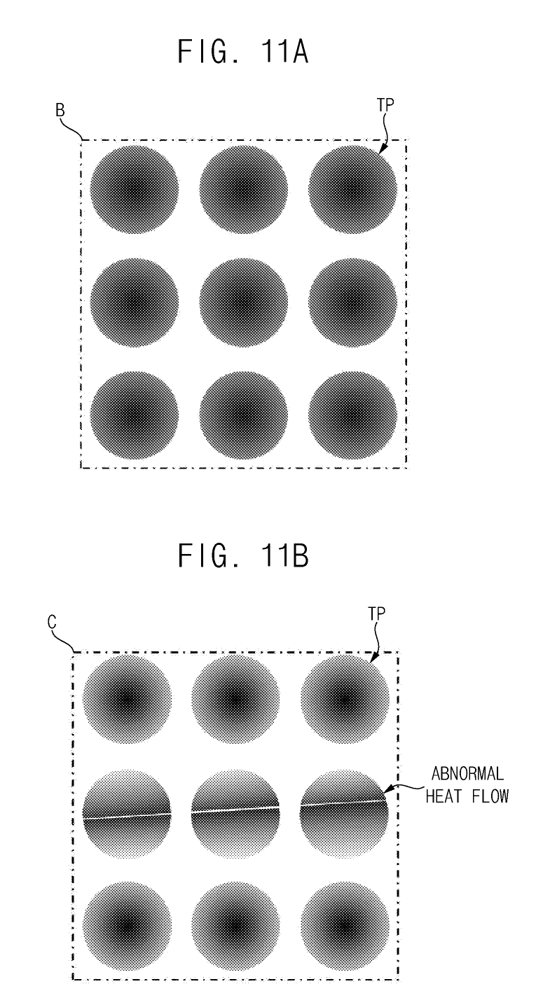

FIG. 10 is a diagram illustrating thermal images in accordance with example embodiments. FIG. 11A is an enlarged view of a portion ‘B’ of FIG. 10. FIG. 11B is an enlarged view of a portion ‘C’ of FIG. 10.

The defect inspection apparatus may include substantially the same components as those of the defect inspection apparatus illustrated in FIGS. 1 to 10, except that the thermal imaging camera generates a plurality of thermal images. Therefore, the same components are denoted by the same reference numerals, and repeated descriptions of the same components may be omitted.

Referring to FIG. 10, the thermal imaging camera 220 may generate a plurality of thermal images TI classified in time series. After a plurality of spot beams SB are emitted and a target structure TS is heated, a target structure TS may cool down over time, so that the plurality of thermal images TI may include images having different temperature distributions depending on the temperature change in an irradiation area IA of the target structure TS. The thermal imaging camera 220 may transmit the plurality of thermal images TI to the controller 300.

Referring to FIGS. 11A and 11B, the controller 300 may process the plurality of thermal images TI to detect a surface defect. The controller 300 may select a target thermal image TI’ among the plurality of thermal images TI transmitted from the thermal imaging camera 220 and perform post-processing. The target thermal image TI’ may correspond to an image in which a point where heat transfer is blocked is present.

As illustrated in FIG. 11A, the thermal image TI generated first among the plurality of thermal images TI may represent a temperature distribution in which the center of each of the plurality of thermal points TP has a higher temperature. After the plurality of spot beams SB are emitted, the plurality of thermal points TP are uniformly heated regardless of whether a surface defect is present, so the thermal image TI generated first may be an image representing a temperature distribution having no point where the temperature distribution rapidly changes. Therefore, the first thermal image TI may be relatively unsuitable for performing post-processing for detecting surface defects.

As illustrated in FIG. 11B, the target thermal image TI’ may show points at which abnormal heat distribution occurs, such as blockage of heat transfer in at least some of the plurality of thermal points TP.

The controller 300 may apply a Sobel filter to the target thermal image TI’. The Sobel filter may correspond to a filter that extracts an edge by determining gradients of pixel values in an image. The controller 300 may generate the inspection image EI by displaying areas in which the temperature distribution rapidly changes on the target thermal image TI’ using the Sobel filter, thereby representing an outline of a surface defect. Since the inspection image EI is an image including the outline of a portion in which a surface defect occurs, the controller 300 may detect a surface defect on the target structure TS by identifying the target as having a defect when an outline appears in the inspection image EI, and identifying the target as being defect-free when no outline appears in the inspection image EI.

Since an optimum image among the plurality of thermal images TI is selected and analyzed for inspecting surface defects, a defect inspection apparatus having higher reliability can be provided.

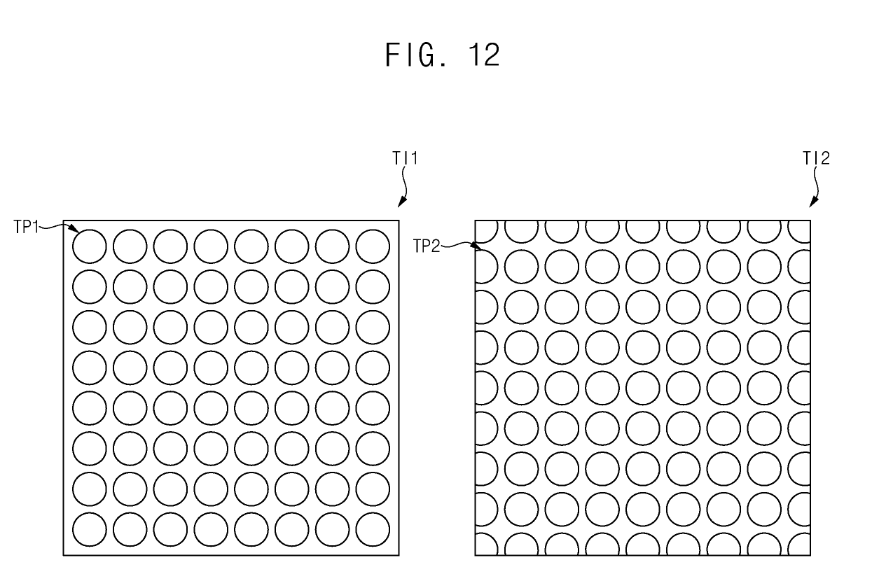

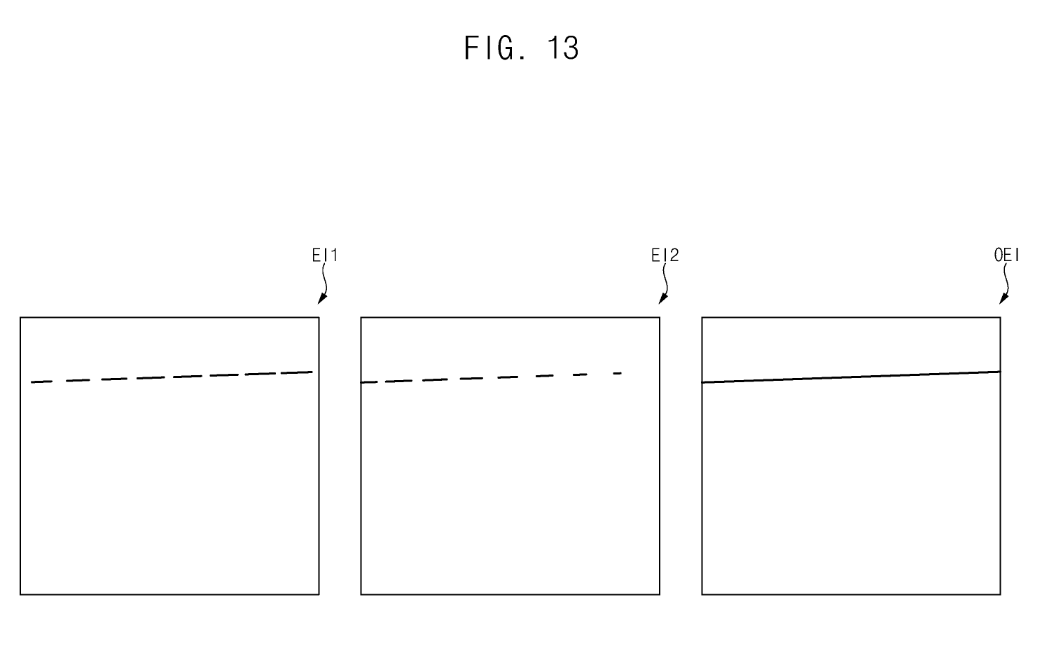

FIG. 12 is a diagram illustrating thermal images according to example embodiments. FIG. 13 is a diagram illustrating inspection images according to example embodiments.

The defect inspection apparatus with reference to FIGS. 12 to 13 is substantially the same as the defect inspection apparatus described with reference to FIGS. 1 to 11 except that the controller detects a surface defect using an overlapped inspection image. Thus, same reference numerals will be used to refer to the same or like elements and any further repetitive explanation concerning the above elements may be omitted.

Referring to FIG. 12, the image detector 200 may generate a first thermal image TI1 and a second thermal image TI2.

First, the laser generator 110 may generate a first pulse laser in response to a first trigger signal. The laser controller 120 may control a plurality of mirrors 126 over time to divide the first pulse laser, thereby generating a plurality of first spot beams. The plurality of first spot beams may be emitted onto an irradiation area IA of the target structure TS in a shape corresponding to a raster scan profile, and the image detector 200 may detect thermal radiation emitted from the target structure TS to generate a first thermal image TI1. The first thermal image TI1 may have a shape in which a plurality of first thermal points TP1 are arranged in an array.

Subsequently, the laser generator 110 may generate a second pulse laser in response to a second trigger signal. The laser controller 120 may control the plurality of mirrors 126 over time to divide the second pulse laser, thereby generating a plurality of second spot beams. The plurality of second spot beams may be emitted onto the irradiation area IA of the target structure TS in a shape corresponding to a raster scan profile. In this case, compared with the profile in which the plurality of first spot beams are emitted, the plurality of second spot beams may be emitted at positions offset by a predetermined interval within the irradiation area IA. The image detector 200 may detect thermal radiation emitted from the target structure TS to generate the second thermal image TI2. The second thermal image TI2 may have a shape in which a plurality of second thermal points TP2 are arranged in an array. The second thermal image TI2 may have a shape in which the plurality of second thermal points TP2 are disposed at positions spaced by the predetermined interval from the plurality of first thermal points TP1, respectively. The image detector 200 may transmit the first thermal image TI1 and the second thermal image TI2 to the controller 300.

Referring to FIG. 13, the controller 300 may post-process the first thermal image TIb and the second thermal image TI2 to generate a first inspection image EI1 and a second inspection image EI2, respectively, and may generate an overlapped inspection image OEI by overlapping the first inspection image EIb and the second inspection image EI2.

The controller 300 may perform post-processing on the first thermal image TI1 to generate the first inspection image EI1 that represents, as outlines, abnormal heat distributions occurring in regions where the plurality of first thermal points TP1 are located on the first thermal image TI1. Likewise, the controller 300 may perform post-processing on the second thermal image TI2 to generate the second inspection image EI2 that represents, as outlines, abnormal heat distributions occurring in regions where the plurality of second thermal points TP2 are located on the second thermal image TI2. In this case, since the plurality of first thermal points TP1 do not cover the entirety of the irradiation area IA, only a portion of a surface defect located on the target structure TS may be indicated. Because the plurality of second thermal points TP2 may be generated at positions spaced by the predetermined interval from the plurality of first thermal points TP1, portions of a surface defect that are not covered by the plurality of first thermal points TP1 can be indicated.

A target may be identified as having a defect when an outline appears on the overlapped inspection image OEI, and may be identified as defect-free when no outline appears on the overlapped inspection image OEI, thereby detecting a surface defect on the target structure TS.

Hereinafter, a semiconductor inspection method using the defect inspection apparatus of FIG. 1 will be described.

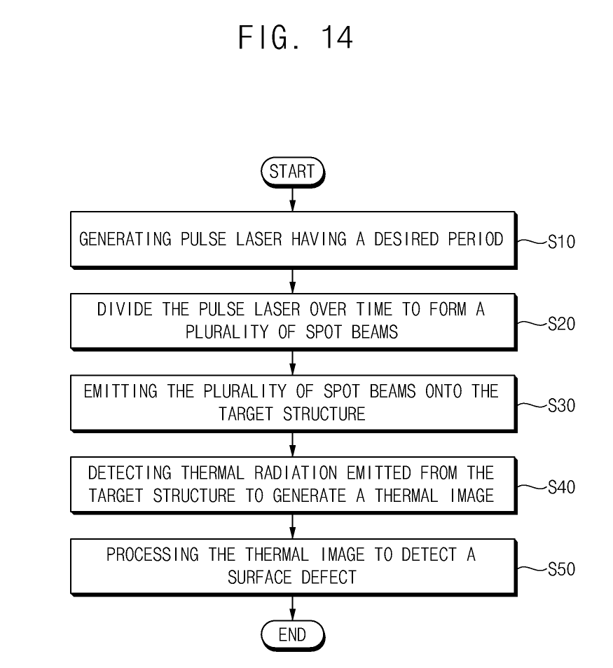

FIG. 14 is a flowchart illustrating a method of inspecting a surface defect of a semiconductor device according to example embodiments.

First, a pulse laser P having a constant period may be generated (S10), and the pulse laser P may be divided over time to form a plurality of spot beams SB (S20).

First, the pulse laser P may be generated. The pulse laser P having constant periodicity may be generated by the laser generator 110. A pulse signal may be generated in response to a trigger signal, which is an inspection start signal applied from the controller 300. For example, a pulse signal having a square waveform with a constant period T may be generated. Accordingly, a pulse laser P that is repeatedly emitted with an active mode and an inactive mode within one period T according to the square waveform may be generated.

According to the pulse signal, a laser having characteristics suitable for inspecting the surface of the target structure TS may be generated. For example, the pulse laser P may have an average output within a range of 100 W or less. The pulse energy of the pulse laser P may be within a range of 10 mJ or less. The pulse duration of the pulse laser P may be within a range of 10 ms or less. The pulse duration may correspond to a time in which the active mode lasts within one period T of the pulse laser P.

Subsequently, the pulse laser P may be divided over time to form a plurality of spot beams SB.

The pulse laser P generated by the laser generator 110 may be incident on the laser controller 120. The laser controller 120 may be a galvanometer scanner including a pair of galvanometer mirrors to continuously emit the pulse laser P from one position to a predetermined position of the target structure TS according to a predetermined scanning direction.

The pulse laser P may be divided over time by the laser controller 120 to proceed in different directions. The pulse laser P may be incident on the plurality of mirrors 126, which are provided to change their angles, and accordingly be divided. By changing the angles of the plurality of mirrors 126 for each period T of the pulse laser P, a plurality of spot beams SB may be formed.

The plurality of spot beams SB may be incident on the lens portion 128 before being emitted onto the target structure TS. The plurality of spot beams SB may pass through the lens portion 128 and be adjusted to be focused on the target structure TS. The lens portion 128 may include a condenser lens that collects light or a diffusion lens that diffuses light. As the plurality of spot beams SB pass through the lens portion 128, the size and energy of the plurality of spot beams SB may be adjusted according to characteristics of the target structure TS and the inspection purpose. For example, diameters of the plurality of spot beams SB may be adjusted to be within a range of 1.5 mm or less.

Thereafter, the plurality of spot beams SB may be emitted onto the target structure TS (S30).

The target structure TS may have an irradiation area IA on an upper surface. The irradiation area IA may have a rectangular shape extending in a first direction x and a second direction y perpendicular to the first direction x. For example, a width of the irradiation area IA may be within a range of 9.5 mm or less, and a height of the irradiation area IA may be within a range of 13.3 mm or less. The irradiation area IA may be variably set according to the type of semiconductor to be inspected.

The plurality of spot beams SB may be emitted onto the irradiation area IA of the target structure TS. The plurality of spot beams SB may be emitted onto the irradiation area IA to have a raster scan profile.

Subsequently, thermal radiation emitted from the target structure TS may be detected to generate a thermal image TI (S40).

After the plurality of spot beams SB are entirely emitted onto the target structure TS, thermal radiation generated from the target structure TS may be detected to generate a thermal image TI. As the plurality of spot beams SB are emitted onto the target structure TS, points on the target structure TS at which the plurality of spot beams SB are irradiated may be heated, thereby forming a plurality of thermal points TP that emit thermal radiation. The thermal radiation may correspond to infrared radiation detectable by the thermal imaging camera 220. The plurality of thermal points TP may be arranged in a shape corresponding to the profile in which the plurality of spot beams SB are irradiated. For example, the plurality of thermal points TP may be arranged in an array form in which they are spaced apart from each other at predetermined intervals in the first direction x and the second direction y.

Thermal radiation emitted from the plurality of thermal points TP may be incident on the focusing lens 210. The focusing lens 210 may concentrate thermal radiation emitted from the target structure TS onto the thermal imaging camera 220. The focusing lens 210 may be provided to adjust magnification so that the thermal radiation are concentrated onto the thermal imaging camera 220 to allow the thermal imaging camera to generate an image having optimal resolution according to the size of the irradiation area IA and the distance to the irradiation area IA of the target structure TS.

The thermal radiation that have passed through the focusing lens 210 may be incident on the thermal imaging camera 220. The thermal imaging camera 220 may include an infrared measurement camera. The thermal imaging camera 220 may generate the shape of the thermal radiation as a thermal image TI. The thermal imaging camera 220 may use a pulse-type thermal image generation method that detects thermal radiation emitted from an inspection object that is instantaneously heated.

The thermal image TI may represent a temperature distribution on the irradiation area IA through the generated thermal image TI by detecting thermal radiation emitted from the target structure TS. For example, a portion having a higher temperature may be expressed in a darker color, and a portion having a lower temperature may be expressed in a lighter color. For example, a thermal image TI may be formed in which the color becomes darker toward the centers of the plurality of thermal points TP.

The thermal imaging camera 220 may form at least one thermal image TI. After the plurality of spot beams SB are emitted onto the target structure TS and the target structure TS is heated, the target structure TS cools down over time, and accordingly the thermal image TI may include images having different temperature distributions according to temperature changes on the irradiation area IA of the target structure TS. For example, the thermal imaging camera 220 may repeatedly capture the irradiation area IA at preset time intervals to form a plurality of thermal images TI.

Thereafter, a surface defect may be detected by processing the thermal image TI (S50).

Post-processing may be performed on the thermal image TI to generate an inspection image EI. For example, post-processing may be performed on the thermal image TI to generate the inspection image EI. The inspection image EI may correspond to an image in which a surface defect is visualized.

The inspection image EI may correspond to an image to which a Sobel filter is applied to the thermal image TI. The Sobel filter may be a filter that extracts an edge by calculating gradients of pixel values in the thermal image TI. An inspection image EI may be generated by marking areas in which the temperature distribution rapidly changes using the Sobel filter. Since the inspection image EI is an image including an outline of a portion where a surface defect occurs, a target may be identified as having a defect when an outline appears on the inspection image EI, and may be identified as defect-free when no outline appears on the inspection image EI, thereby detecting a surface defect on the target structure TS.

A method of inspecting a defect of a semiconductor device may include generating a pulse laser having a constant period according to a pulse signal, dividing the pulse laser over time according to a control signal matched with the pulse signal so that the pulse laser proceeds in different directions in each constant period to thereby form a plurality of spot beams, sequentially emitting the plurality of spot beams onto a target structure, detecting thermal radiation emitted from the target structure irradiated with the plurality of spot beams to generate at least one thermal image, and processing the at least one thermal image to detect a surface defect of the target structure.

The pulse laser may have an average power within a range of 100 W or less, a maximum pulse energy within a range of 10 mJ or less, and a pulse length within a range of 10 ms or less.

The forming the plurality of spot beams may include changing angles of a plurality of mirrors for each constant period of the pulse laser according to the control signal to divide the pulse laser over time to form the plurality of spot beams and the emitting the plurality of spot beams may include emitting the plurality of spot beams onto the target structure in a raster scan manner.

The processing the at least one thermal image to detect a surface defect of the target structure may include applying a Sobel filter to the thermal image to generate a defect image illustrating an outline of the surface defect and detecting the surface defect based on the defect image.

The generating the thermal image may include continuously detecting a temperature distribution of the thermal radiation over time to generate a plurality of thermal images, selecting a target thermal image among the plurality of thermal images and processing the target thermal image to detect the surface defect of the target structure.

Additionally, the defect inspection apparatus according to example embodiments may instantaneously heat the target structure using the pulse laser and detect the surface defect through the pulse-type thermal imaging camera. Accordingly, compared with the related art using a transient-type infrared camera, the surface defect can be detected at a higher speed.

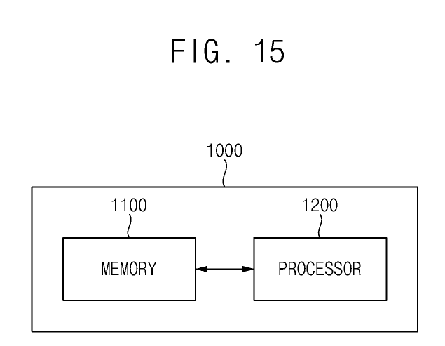

FIG. 15 is a block diagram of a system according to one or more embodiments

As shown in FIG. 15, the system 1000 may include a memory 1100 and a processor 1200 to implement, for example, the controller 300 shown in FIG. 1. However, the configuration shown in FIG. 15 is an example for implementing the embodiments, and other hardware and software configurations may be additionally included in the system 1000 as will be understood to one of ordinary skill in the art from the disclosure herein. According to one or more embodiments, the system 1000 may be implemented in the form of an electronic device.

The system 1000 according to one or more embodiments may be configured to perform operations corresponding to those recited in relation to at least the controller 300 of FIG. 1

The memory 1100 may store commands or data related to at least one other component of the system 1000. Also, the memory 1100 may be accessed by the processor 1200, and reading/writing/modifying/deleting/updating of data may be performed by the processor 1200.

The term memory may include the memory 1100, a read-only memory (ROM) or a random access memory (RAM) in the processor 1200, or a memory card (e.g., a micro secure digital (SD) card or a memory stick) mounted in the system 1000. In addition, the memory 1100 may store programs and data for configuring various screens to be displayed on a display area of a display.

According to one or more embodiments, the memory 1100 may include a non-volatile memory capable of maintaining stored information even if power supply is interrupted, and a volatile memory requiring continuous power supply to maintain stored information. For example, the non-volatile memory may be implemented as at least one of one time programmable ROM (OTPROM), programmable ROM (PROM), erasable and programmable ROM (EPROM), electrically erasable and programmable ROM (EEPROM), mask ROM, or flash ROM, and the volatile memory may be implemented as at least one of dynamic RAM (DRAM), static RAM (SRAM), or synchronous dynamic RAM (SDRAM).

The processor 1200 may be electrically connected to the memory 1100 to control all operations and functions of the system 1000.

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

At least one of the devices, units, components, modules, units, or the like including the controller 300 of FIG. 1 represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A defect inspection apparatus, comprising:
a laser generator configured to generate a pulse laser having a constant period based on a pulse signal;
a laser controller configured to:
form a plurality of spot beams by dividing the pulse laser over time such that the pulse laser proceeds in different directions in each constant period based on a control signal matched with the pulse signal, and
heat a surface of a target structure by sequentially emitting the plurality of spot beams to the target structure;
an image detector configured to generate at least one thermal image by detecting thermal radiation emitted from the target structure irradiated by the plurality of spot beams; and
a controller configured to detect a surface defect of the target structure by processing the at least one thermal image.

2. The defect inspection apparatus of claim 1, wherein the pulse laser has an average power of 100 W or less, the pulse laser has a maximum pulse energy of 10 mJ or less, and the pulse laser has a pulse length of 10 ms or less.

3. The defect inspection apparatus of claim 1, wherein the plurality of spot beams have a circular beam cross-section or an elliptical beam cross-section.

4. The defect inspection apparatus of claim 1, wherein the laser controller comprises a galvanometer scanner comprising a plurality of mirrors configured to reflect the pulse laser.

5. The defect inspection apparatus of claim 4, wherein the plurality of mirrors comprise:
a first mirror configured to reflect the pulse laser; and
a second mirror configured to form the plurality of spot beams by reflecting the pulse laser reflected from the first mirror, and
wherein, based on the control signal, the first mirror is configured to rotate to control movements of the plurality of spot beams in a first direction, and the second mirror is configured to rotate to control movements of the plurality of spot beams in a second direction intersecting the first direction.

6. The defect inspection apparatus of claim 4, wherein the laser controller is configured to divide the pulse laser over time into the plurality of spot beams by changing angles of the plurality of mirrors for each constant period of the pulse laser based on the control signal, and
wherein the plurality of spot beams are emitted to the target structure in a raster scan manner.

7. The defect inspection apparatus of claim 1, wherein the controller is configured to generate an inspection image illustrating an outline of the surface defect by applying a Sobel filter to the at least one thermal image, and detect the surface defect based on the inspection image.

8. The defect inspection apparatus of claim 1, wherein the at least one thermal image comprises a shape of a plurality of thermal points generated at positions on the target structure at which the plurality of spot beams are emitted, and
wherein the plurality of thermal points are arranged in an array.

9. The defect inspection apparatus of claim 1, wherein the image detector comprises:
a thermal imaging camera configured to generate the at least one thermal image; and
a focusing lens configured to concentrate the thermal radiation generated on the target structure onto the thermal imaging camera.

10. The defect inspection apparatus of claim 9, wherein the thermal imaging camera comprises an infrared camera configured to detect infrared rays emitted from the target structure.

11. A defect inspection apparatus, comprising:
a laser generator configured to generate a pulse laser having a constant period based on a pulse signal;
a laser controller configured to:
form a plurality of spot beams by dividing the pulse laser over time such that the pulse laser proceeds in different directions in each constant period based on a control signal matched with the pulse signal; and
heat a surface of a target structure by sequentially emitting the plurality of spot beams to the target structure;
an image detector configured to generate a plurality of thermal images by detecting thermal radiation emitted from the target structure over time after the plurality of spot beams are entirely emitted to the target structure; and
a controller configured to detect a surface defect of the target structure by selecting and processing a target thermal image among the plurality of thermal images.

12. The defect inspection apparatus of claim 11, wherein the pulse laser has an average power of 100 W or less, the pulse laser has a maximum pulse energy of 10 mJ or less, and the pulse laser has a pulse length of 10 ms or less.

13. The defect inspection apparatus of claim 11, wherein the plurality of spot beams have a circular beam cross-section or an elliptical beam cross-section.

14. The defect inspection apparatus of claim 11, wherein the laser controller comprises a galvanometer scanner comprising a plurality of mirrors configured to reflect the pulse laser.

15. The defect inspection apparatus of claim 14, wherein the plurality of mirrors comprise:
a first mirror configured to reflect the pulse laser; and
a second mirror configured to form the plurality of spot beams by reflecting the pulse laser reflected from the first mirror, and
wherein, based on the control signal, the first mirror is configured to rotate to control movements of the plurality of spot beams in a first direction, and the second mirror is configured to rotate to control movements of the plurality of spot beams in a second direction intersecting the first direction.

16. The defect inspection apparatus of claim 14, wherein the laser controller is configured to:
divide the pulse laser over time and form the plurality of spot beams by changing angles of the plurality of mirrors for each constant period of the pulse laser based on the control signal and
emit the plurality of spot beams to the target structure in a raster scan manner.

17. The defect inspection apparatus of claim 11, wherein the controller is further configured to:
generate an inspection image representing an outline of the surface defect by applying a Sobel filter to the target thermal image; and
detect the surface defect based on the inspection image.

18. The defect inspection apparatus of claim 11, wherein the target thermal image comprises a shape of a plurality of thermal points generated at positions on the target structure at which the plurality of spot beams are emitted, and
wherein the plurality of thermal points are arranged in an array.

19. The defect inspection apparatus of claim 11, wherein the image detector comprises:
a thermal imaging camera configured to generate the target thermal image; and
a focusing lens configured to concentrate the thermal radiation generated on the target structure onto the thermal imaging camera.

20. A defect inspection apparatus, comprising:
a laser generator configured to generate a pulse laser having a constant period based on a pulse signal;
a laser controller comprising a galvanometer scanner comprising a plurality of mirrors configured to reflect the pulse laser, the laser controller configured to:
divide the pulse laser over time and form a plurality of spot beams by changing angles of the plurality of mirrors for each constant period of the pulse laser based on a control signal; and
heat a surface of a target structure in a raster scan manner by sequentially emitting the plurality of spot beams onto the target structure;
an image detector configured to generate at least one thermal image by detecting thermal radiation emitted from the target structure over time after the plurality of spot beams are entirely emitted to the target structure; and
a controller configured to generate an inspection image illustrating an outline of a surface defect by applying a Sobel filter to the at least one thermal image, and detect the surface defect based on the inspection image.
